(19) United States
(12) Patent Application Publication
(10) Pub. No.: US 2026/0179096 A1
(43) Pub. Date: Jun. 25, 2026

(54) FRAUD RISK MITIGATION USING QUANTUM MARKOV CHAINS

(71) Applicant: American Express Travel Related Services Company, Inc., New York, NY (US)

(72) Inventors: Hiranmayi PALANKI, Tampa, FL (US); John Thomas HANCOCK, III, Deerfield Beach, FL (US)

(73) Assignee: American Express Travel Related Services Company, Inc., New York, NY (US)

(21) Appl. No.: 19/001,154

(22) Filed: Dec. 24, 2024

(51) Int. Cl. G06Q 20/40; G06N 10/60

(52) U.S. Cl. CPC G06Q 20/4016; G06N 10/60

(57) ABSTRACT

Disclosed herein are system, method, and computer program product embodiments for detecting a fraudulent transaction. In an embodiment, runtime data comprising one or more metrics are received from a client device. A quantum computer is configured so as to simulate transition probabilities of one or more Markov chains by processing a plurality of qubits using a quantum circuit. A fraudulent transaction is detected based on at least a measurement value of the plurality of qubits. One or more packets configured to stop the fraudulent transaction are transmitted to the client device. A respective initial state of each qubit of the plurality of qubits is obtained by encoding the runtime data.

### TECHNICAL FIELD

Aspects relate to systems and methods for fraud mitigation using quantum Markov chains.

### BACKGROUND

Fraud in financial services refers to any illegal act characterized by account take over, exposed payment cards on the dark web, e-skimming, info stealing malware, ransomware, phishing, social engineering, multi factor authentication (MFA) bypass, Captcha bypass, Man in the browser, payment transaction fraud, economic extortion, sensitive data theft or exploiting point of sale system vulnerabilities, perpetuated by threat actors and cyber criminals. Fraud risks can lead to severe financial and reputational damages to financial institutions if not managed adequately. However, a technical challenge relates to effectively detect fraudulent transactions and fraud attacks in a timely fashion.

### SUMMARY

Disclosed herein are system, apparatus, device, method and/or computer program product embodiments, and/or combinations and sub-combinations thereof, for detecting a fraudulent transaction.

An example embodiment comprises receiving, by a computer processor and from a client device, runtime data comprising one or more metrics; configuring, by the computer processor, a quantum computer so as to simulate transition probabilities of one or more Markov chains by processing a plurality of qubits using a quantum circuit; detecting a fraudulent transaction based on at least a measurement value of the plurality of qubits; and transmitting, by the computer processor to the client device, one or more packets configured to stop the fraudulent transaction. A respective initial state of each qubit of the plurality of qubits is obtained by encoding the runtime data.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1 is a block diagram of an environment for a fraud mitigation system, in accordance with an embodiment of the present disclosure.

FIG. 2A is a schematic that illustrates an attack graph, in accordance with an embodiment of the present disclosure.

FIG. 2B is a schematic that illustrates an attack graph, in accordance with an embodiment of the present disclosure.

FIG. 2C is a schematic that illustrates an attack graph, in accordance with an embodiment of the present disclosure.

FIG. 2D is a schematic that illustrates an attack graph, in accordance with an embodiment of the present disclosure.

FIG. 2E is a schematic that illustrates an attack graph, in accordance with an embodiment of the present disclosure.

FIG. 2F is a schematic that illustrates an attack graph, in accordance with an embodiment of the present disclosure.

FIG. 2G is a schematic that illustrates an attack graph, in accordance with an embodiment of the present disclosure.

FIG. 2H is a schematic that illustrates an attack graph, in accordance with an embodiment of the present disclosure.

FIG. 3 is a schematic that illustrates Markov chains, in accordance with an embodiment of the present disclosure.

FIG. 4 is a schematic that illustrates a fraud analysis flow, in accordance with an embodiment of the present disclosure.

FIG. 5A is a graph that illustrates a fraud probability, in accordance with an embodiment of the present disclosure.

FIG. 5B is a graph that illustrates a fraud probability, in accordance with an embodiment of the present disclosure.

FIG. 5C is a graph that illustrates a fraud probability, in accordance with an embodiment of the present disclosure.

FIG. 6 is a schematic that illustrates a quantum circuit, in accordance with an embodiment of the present disclosure.

FIG. 7 is an example method for detecting a fraudulent transaction, in accordance with an embodiment of the present disclosure.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

The following aspects are described in sufficient detail to enable those skilled in the art to make and use the disclosure. It is to be understood that other aspects are evident based on the present disclosure, and that system, process, or mechanical changes may be made without departing from the scope of an aspect of the present disclosure.

In the following description, numerous specific details are given to provide a thorough understanding of aspects. However, it will be apparent that aspects may be practiced without these specific details. To avoid obscuring an aspect, some well-known circuits, system configurations, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the system may be operated in any orientation.

Certain aspects have other steps or elements in addition to or in place of those mentioned. The steps or elements will become apparent to those skilled in the art from a reading of the following detailed description when taken with reference to the accompanying drawings.

Aspects of the present disclosure relate to systems and methods for detecting a fraudulent transaction. As used herein, the fraudulent transaction may correspond to any fraud or compromise that has occurred or may occur. In particular, the present disclosure relates to using a quantum computer to model one or more Markov chains to detect the fraudulent transaction based on runtime data. The runtime data may include application runtime data (e.g., keystroke rates, click frequencies, IP address, authentication, failure counts, bad bots, credential stuffing, web exploits) and middleware runtime data (e.g., merchant time, time of day, transaction amount, point of sale information).

As described in the background, fraud can lead to severe financial and reputation damages to financial institutions. Current systems use classical machine learning (ML) algorithms and graph databases for fraud detection, analysis, and prevention. However, a technical challenge relates to effectively detect fraudulent transactions and fraud attacks in a timely fashion. Fraud is usually detected and reported too late, resulting in failing to recoup financial losses.

The present disclosure provides an improvement in the technological field of fraud risk identification, analysis and risk mitigation through the use of quantum Markov chains. Embodiments described herein provide the advantage of effectively identifying and minimizing fraud risk exposure. For example, a new attack pattern (e.g., previously unknown fraud patterns) may be identified. In addition, the present disclosure presents the advantage of accelerated risk mitigation with proactive fraud detection and preventative controls. Thus, the number of fraud incidents in organizations may be reduced. In addition, the present disclosure provides the advantage of accelerated real-time detection of fraud and accelerated compliance with anti-fraud laws and regulations due to the analyzing of multiple Markov chains simultaneously.

Various embodiments of these features will now be discussed with respect to the corresponding figures.

### System Overview and Function

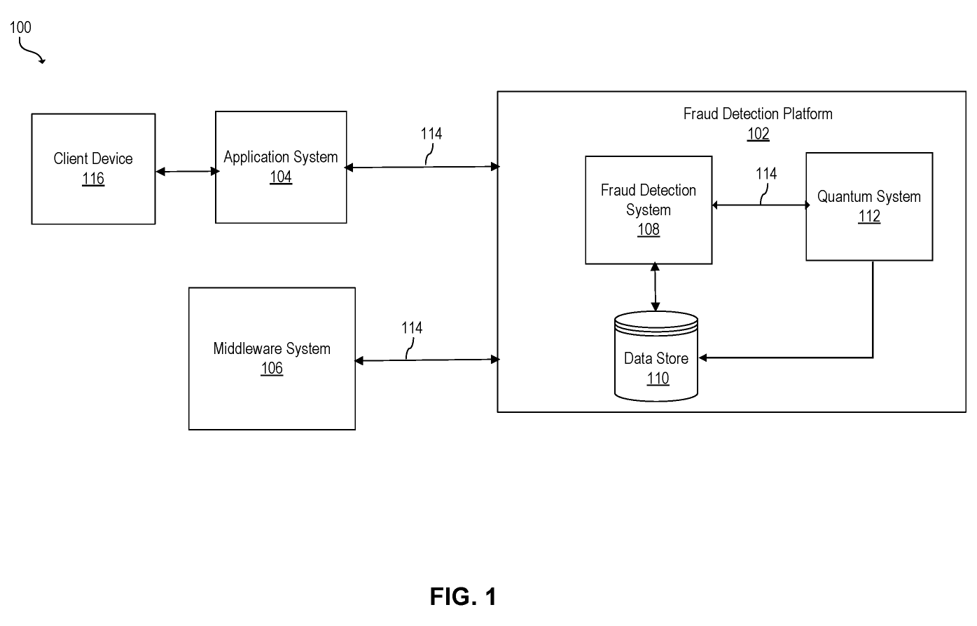

FIG. 1 is a block diagram of a fraud detection environment 100, in accordance with an embodiment of the present disclosure. Environment 100 may include a fraud detection platform 102, an application system 104, a middleware system 106, and a client device 116. Fraud detection platform 102 may include a fraud detection system 108, a data store 110, and a quantum system 112. Application system 104 and middleware system 106 can communicate with fraud detection platform 102 via a network 114. Fraud detection platform 102 may execute the methods described herein to detect a fraudulent transaction.

Fraud detection platform 102 may provide a cluster computing platform or a cloud computing platform to receive data and detect fraudulent transactions. Fraud detection platform 102 may manage or access application system 104. For example, fraud detection platform 102 may access application system 104 via application programming interface (API) functionality. As used herein, the API may comprise any software capable of performing an interaction between one or more software components as well as interacting with and/or accessing one or more data storage elements (e.g., server systems, databases, hard drives, and the like). An API may comprise a library that specifies routines, data structures, object classes, variables, and the like. Thus, an API may be formulated in a variety of ways and based upon a variety of specifications or standards, including, for example, POSIX, the MICROSOFT WINDOWS API ®, a standard library such as C++, a JAVA API, and the like.

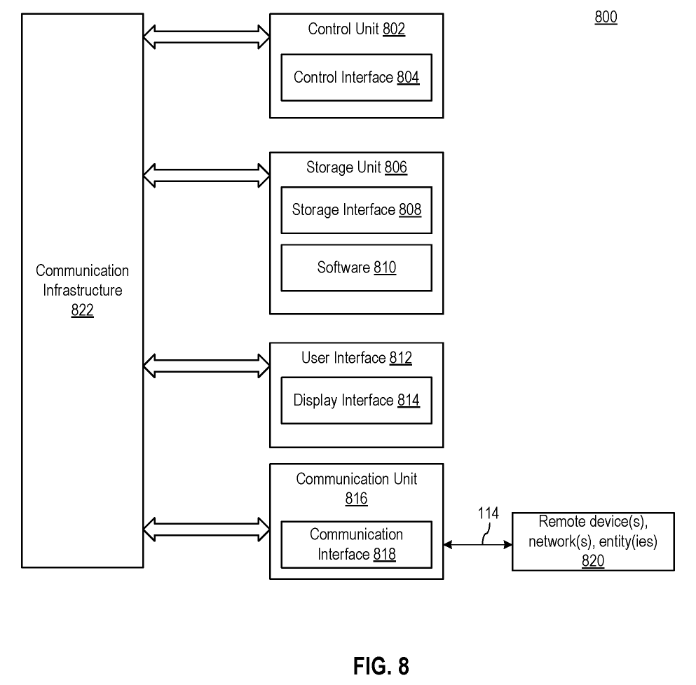

Fraud detection system 108 may operate on one or more servers and/or databases. The servers may be a variety of centralized or decentralized computing devices. For example, a server may be grid-computing resources, a virtualized computing resource, peer-to-peer distributed computing devices, a mobile device, a laptop computer, a desktop computer, or a combination thereof. The servers may be centralized in a single room, distributed across different rooms, distributed across different geographic locations, or embedded within network 114. In some aspects, fraud detection system 108 may be implemented using computer system 800 described with reference to FIG. 8. Fraud detection system 108 may receive data from application system 104 and middleware system 104 and may perform one or more operations on the data. For example, application system 104 and/or middleware system 106 may send a request to fraud detection platform 102. The request may include runtime data. The request and corresponding data may be sent via API (e.g., REST API). Fraud detection system 108 may process the data and send the processed data to quantum system 112 for analysis using Markov chains. Fraud detection system 108 may also collect and process data that includes cybersecurity indicators or threat intelligence indicators (e.g., device count, device inventory log, intrusion attempts).

Client device 116 may represent one or more devices in connection with application system 104, middleware system 106, and/or fraud detection platform 102. For example, client device 116 may be a mobile phone, tablet, laptop, desktop, or other devices used by an end-user (e.g., a customer, an account holder). In some aspects, client device 116 may be a server connected over network 114 wherein a user can communicate with application system 104. In some aspects, client device 116 may be implemented using computer system 800 described with reference to FIG. 8.

Fraud detection platform 102 may track one or more metrics corresponding to application system 104. The one or more metrics may relate to transactions and/or functionality being executed by application system 104. Application system 104 may be accessed from client device 116 via a browser. The metrics may be received as an input from client device 116. For example, the metrics may include application runtime data. The application runtime data may include one or more of keystroke rates, click frequencies, IP address, authentication, failure counts, bad bots, credential stuffing, or web exploits. In some aspects, fraud detection platform 102 may encode the data using an amplitude encoded algorithm. For example, runtime data may be represented as a vector that is encoded to the amplitude of the qubits. In some aspects, the vector may be normalized.

In addition to or alternatively to the one or more metrics from application system 104, fraud detection platform 102 may receive data from middleware system 106. Middleware system 106 may collect middleware runtime data (e.g., merchant time, time of day, transaction amount, point of sale) and may output the data with the request to fraud detection platform 102 via network 114. Middleware system 106 may be associated with a merchant system.

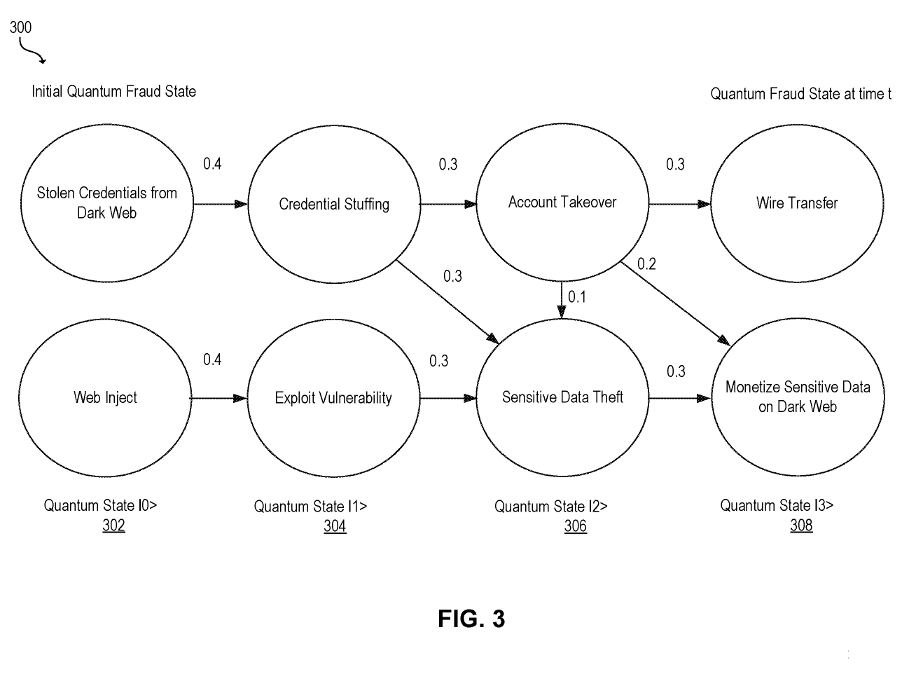

After receiving the request, fraud detection platform 102 may predict a fraud probability. Using Markov chains, fraud detection platform 102 may provide a prediction on a fraud state regarding a future state of fraud based solely on the present state. An example of a Markov chain is further discussed in relation with FIG. 3. In some aspects, data received from application system 104 and/or middleware system 106 may be used to initialize quantum states of quantum system 112. Quantum system 112 may execute one or more transformations on the initial states. Measurements of the states on quantum system 114 may be used to detect a fraudulent transaction. Fraud detection platform 102 may use a streaming service (e.g., Apache Kafka ® platform) for providing a notification to application system 104 and/or middleware system 106 when a fraudulent transaction is detected. The streaming service may also be used to pass a command from fraud detection platform 102 to application system 104 and/or middleware system 106. In some aspects, the notifications and alerts are provided in real time. The alert may include identifiers of flagged users and accounts. In some aspects, fraud detection system may store the identifiers of flagged users and account in data store 110.

Various data may be stored in data store 110 that is accessible to fraud detection system 108. Data store 110 may represent a plurality of data stores 110 that may include relational databases or non-relational databases, as well as other data storage applications or data structures. Moreover, combinations of these databases, data storage applications, and/or data structures may be used together to provide a single, logical, data store. Data stored in data store 110 may be associated with one or more fraud attacks. The data may include data associated with alerts generated by fraud detection platform 102. For example, for each alert generated by quantum system 112, a timestamp and a type of fraud (e.g., phishing, spoofing, digital payment fraud) may be stored in data store 110. In addition, data store 110 may receive and store the identifiers of flagged users or accounts associated with the alert from quantum system 112. Data store 110 may store attack graphs used by quantum system 112. In addition, data store 110 may receive and store detected attack graphs from quantum system 112.

Quantum system 112 may include a quantum computer that performs computation using mechanical properties of matter and may be of a gate type. Quantum system 112 may include a plurality of quantum bits or qubits. Qubits may refer to quantum bits which correspond to the basic unit of quantum information in which a qubit is a two-state (or two-level) quantum system. Quantum system 112 may include a number of qubits. For example, quantum system 112 may include 2 qubits, 4 qubits, 0 qubits, 16 qubits, 32 qubits, 64 qubits, 128 qubits, 256 qubits, 512 qubits, 1024 qubits, or 2048 qubits. In some aspects, quantum system 112 may use 32 qubits of the plurality of available qubits to represent one or more states of the Markov chains. The remaining qubits of the plurality of available qubits may be used for error mitigation.

In some aspects, there may be any number of gates in a quantum circuit used to model the Markov chains. The quantum circuit may be specified as a sequence of quantum gates. Quantum system 112 may apply one or more gates to the plurality of qubits. In some aspects, the quantum circuit may be trained based on attack graphs. The quantum circuit may be trained to assign transitions probabilities between multiple states. The attack graphs may be generated from previously discovered patterns in transaction data and security intelligence. As new attack graphs are discovered by fraud detection platform 102 or received by fraud detection platform 102 (e.g., reported by a fraud intelligence community), the quantum circuit may be retrained. The graphs are used to estimate the probability of attacks given the data simultaneously in the quantum circuit. In some aspects, the quantum circuit may be retrained periodically. For example, the model may be retrained at a preset frequency (e.g., monthly). The number of attack graphs that can be represented simultaneously depend on the number of qubits that are available in quantum system 112.

In some aspects, each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states. Each qubit may be implemented in a physical medium Examples of such physical media include superconducting material, trapped ions, photons, optical cavities, individual electrons trapped within quantum dots, point defects in solids, molecules, or the like.

In some aspects, quantum system 112 may measure the final states of the plurality of qubits. Fraud detection system 108 or quantum system 112 may process the measurement results to detect a fraudulent transaction. For example, quantum system 112 measures the plurality of qubits and transmits the measured value to fraud detection system 108. If any measurement indicates a fraud attack then an alert is generated and transmitted to middleware system 106 and application system 104.

Quantum system 112 may receive a setting relating to a transformation for manipulating the qubits from fraud detection system 108 via network 114. For example, fraud detection system 108 may process the data before feeding the processed data to quantum system 112. Fraud detection system 108 may encode the data into qubits using a data encoding algorithm (e.g., amplitude encoding algorithm). The data encoding algorithm may code a list of floating numbers representing the data into logarithmic base 2 then to qubits. The encoded data may represent the amplitude of the qubit states.

In some aspects, quantum system 112 may include a quantum computer with a quantum hardware (e.g., Quantum Composer platform available from IBM). In some aspects, quantum system 112 may perform computations using quantum gates and quantum bits that can be in a superposition of 0 and 1 states. In some examples, quantum system 112 may include one or more qubit devices, qudit devices and/or qutrit devices. The one or more qubit devices, including for example, fixed-frequency qubit devices, and/or tunable qubit devices. In some examples, the one or more qubit devices may include a resonator device, a coupler device, or other types of devices or components.

In some examples, quantum system 112 may include a superconducting circuit, and/or the qubit devices may be implemented as circuit devices that include Josephson junctions, for example, in superconducting quantum interference device (SQUID) loops or other arrangements, and may be controlled by radio-frequency signals, microwave signals, and bias signals delivered to quantum system 112.

In some aspects, quantum system 112 may execute one or more quantum operations. The one or more quantum operations may include a pre-loaded non-modifiable program. The one or more quantum operations may be pre-loaded by using a template file. The template file may be created or written to indicate information, such as metadata, and/or how to process function calls with parameters associated with the one or more quantum operations.

Fraud detection platform 102, client device 116, application system 104, and middleware system 106 may communicate via network 114. Network 114 may be a telecommunications network, such as a wired or wireless network. Network 114 can span and represent a variety of networks and network topologies. For example, network 114 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in network 114. Cable, Ethernet, digital subscriber line (DSL), fiber optic lines, fiber to the home (FTTH), and plain old telephone service (POTS) are examples of wired communication that may be included in network 114. Further, network 114 can traverse a number of topologies and distances. For example, network 108 can include a direct connection, personal area network (PAN), local area network (LAN), metropolitan area network (MAN), wide area network (WAN), or a combination thereof.

Alternatively or in addition, network 114 may include a quantum communication network including for example, an integrated quantum communication network. In some aspects, the quantum communication network may include an optical communication network and/or a satellite communication network. In some aspects, the quantum communication network may be based on quantum key distribution (QKD), which uses the quantum states of particles (e.g., photons) to form a string of zeros and ones.

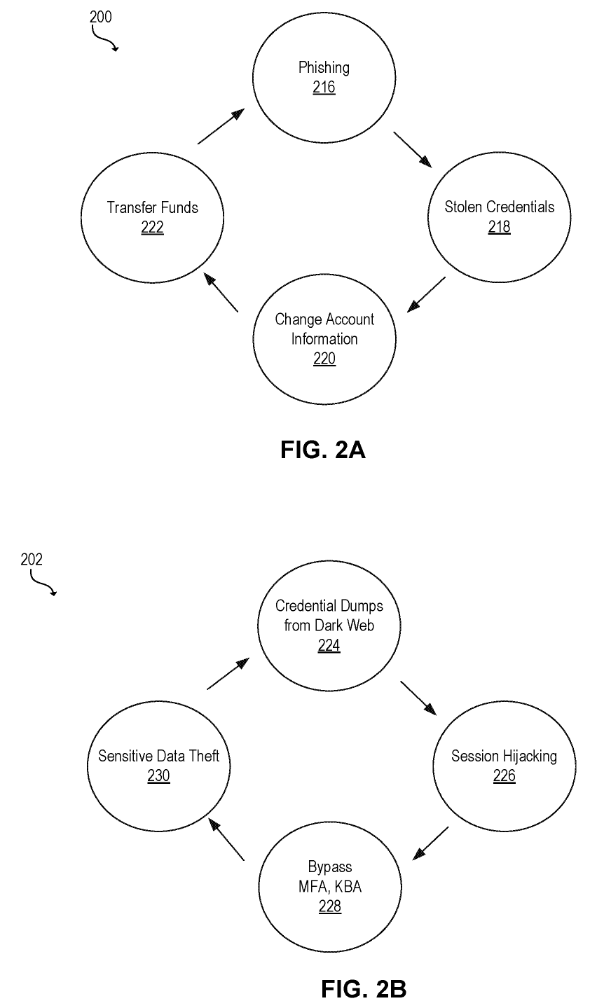

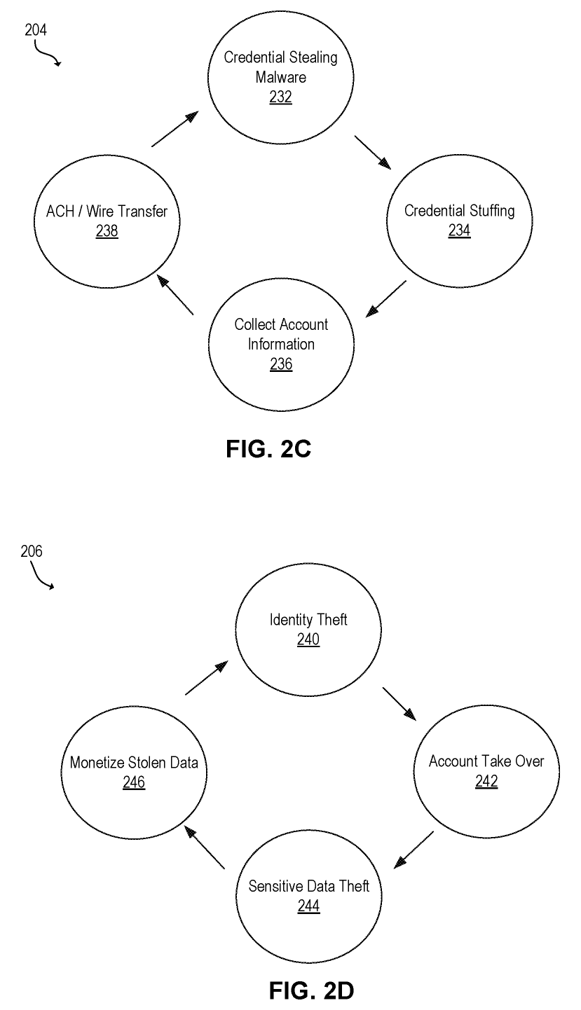

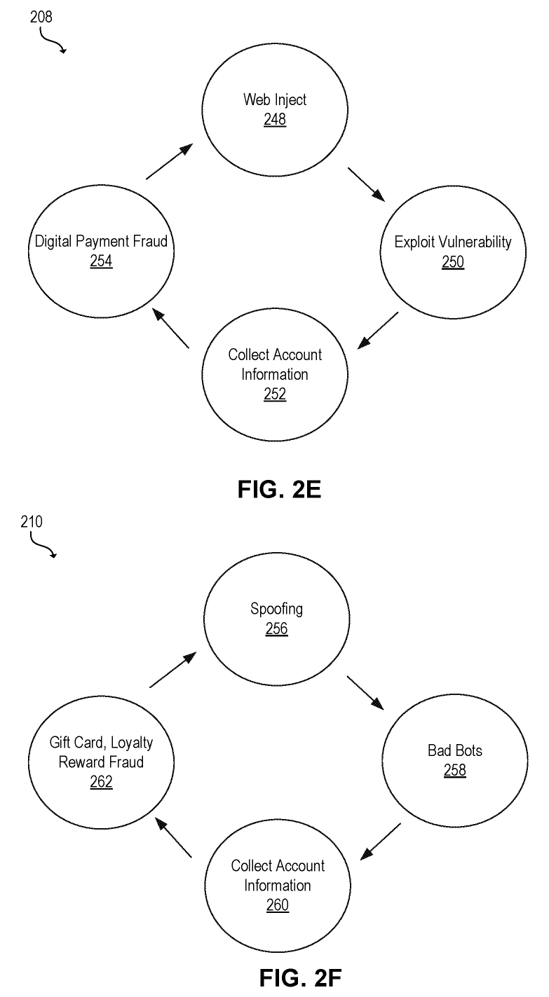

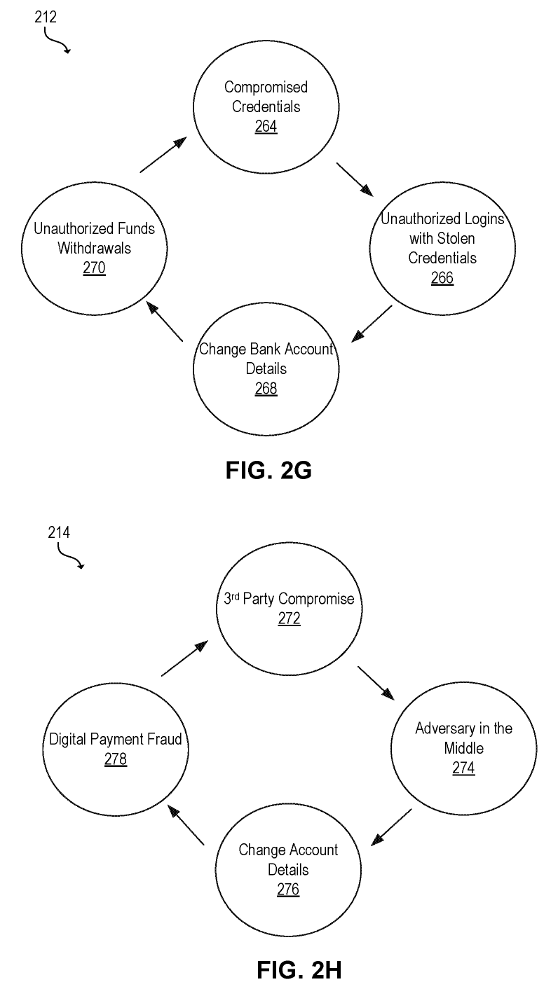

FIGS. 2A-2B are schematics that model attack graphs, in accordance with an embodiment of the present disclosure. The attack graph may represent a payment fraud threats sequential pattern. Each sequential pattern may comprise a series of steps and/or events that an attacker or an actor may perform to be able to carry out a successful fraud attack. The attacker or actor may be a computer system accessing client device 116, application system 104, or middleware system 106. Known sequential patterns may be used by quantum system 112 to estimate a probability of an attack based on data received from application system 104 and/or middleware system 106.

FIG. 2A is a schematic that illustrates an attack graph 200, in accordance with an embodiment of the present disclosure. Attack graph 200 shows the sequential steps of a phishing attack that can happen via an email or a web application. Attach graph 200 may include nodes 216-222 that represent events that may lead to a successful phishing attack. For example, node 216 may represent a phishing step. The phishing step may lead to a credential theft step that is represented in node 218. Stolen credentials obtained by the credential theft may be used to change account information as represented in node 220. After successfully changing the account information, a transfer funds event may occur. The transfer funds event is represented by node 222.

FIG. 2B is a schematic that illustrates an attack graph 202, in accordance with an embodiment of the present disclosure. Attack graph 200 shows the sequential steps of an attack to steal sensitive data. Attack graph 202 may include nodes 224-230. Nodes 224-230 represent a series of events and steps that if completed successfully lead to the sensitive data theft. Node 224 represents the step of an attacker purchasing credential dumps from the dark web. The credentials may be used for session hijacking or session fixation as represented by node 226. Session hijacking or session fixation may happen when a user is accessing a web application or a payment application. The attacker may attempt to bypass multiple factor authentication (MFA) or knowledge base authentication measure (KBA) as represented by node 228. After bypassing MFA or KBA, theft of sensitive data may occur as represented by node 230.

FIG. 2C is a schematic that illustrates an attack graph 204, in accordance with an embodiment of the present disclosure. Attack graph 204 shows the sequential steps of an attack to transfer funds. Attack graph 204 may include nodes 232-238. Nodes 232-238 represent a series of events and steps that if completed successfully lead to the illegal transfer of funds. Node 232 may represent the first step in the attack. An attacker may install a malware on client device 116 to steal credentials of a user of client device 116. The attacker may use the stolen credentials to attempt to access multiple systems as illustrated by node 234. The attacker may collect account information after accessing one or more systems as illustrated by node 236. Using the collected account information, the attacker may perform an automated clearing house (ACH) or a wire transfer as illustrated by node 238.

FIG. 2D is a schematic that illustrates an attack graph 206, in accordance with an embodiment of the present disclosure. Attack graph 206 shows the sequential steps of a fraud attack to monetize stolen data. Attack graph 206 may include nodes 240-246. Nodes 240-246 represent a series of events and steps that if completed successfully lead to the monetizing of stolen data. Node 240 may represent the first step in the attack where the attacker may steal identity information associated with the user. The attacker may use the stolen identity to take over an account associated with the user as illustrated in node 242. The attacker may then steal sensitive data as illustrated in node 244. The attacker may monetize the stolen data as illustrated in node 246.

FIG. 2E is a schematic that illustrates an attack graph 208, in accordance with an embodiment of the present disclosure. Attack graph 208 shows the sequential steps of a web injection attack that may lead to digital payment fraud. Attack graph 208 may include nodes 248-254. Nodes 248-254 represent a series of events and steps that if completed successfully lead to digital payment fraud. Node 248 may represent the first step of the attack where the attacker injects a malicious code into a web page viewed by other users. Malicious web injections can be used to steal sensitive information. Then, the attacker may use injection vulnerabilities to execute unauthorized commands, access data, manipulate the system’s operations, steal data, distribute malicious content, or the like as illustrated by node 250. For example, the attacker may collect account information as illustrated by node 252. The attacker may use the collected account information to perform digital payment fraud as illustrated in node 254.

FIG. 2F is a schematic that illustrates an attack graph 210, in accordance with an embodiment of the present disclosure. Attack graph 210 shows the sequential steps of a spoofing attack that may lead to gift card fraud or loyalty reward fraud. Attack graph 210 may include nodes 256-262. Nodes 256-262 represent a series of events and steps that if completed successfully lead to gift card fraud or loyalty reward fraud. Node 256 may represent the first step of the attack where the attacker may attempt to disguise a sender’s information to appear as a trusted source. Then, the attacker may install bad bots on client device 116 as illustrated in node 258. The bad bots may refer to automated software programs configured to perform malicious or harmful tasks. For example, the bad bots may collect account information as illustrated at node 260. The collected account information may be used by the attacker to commit loyalty fraud or gift card fraud as illustrated in node 262.

FIG. 2G is a schematic that illustrates an attack graph 212, in accordance with an embodiment of the present disclosure. Attack graph 212 shows the sequential steps of an attack to withdraw unauthorized funds using compromised credentials. Attack graph 212 may include nodes 264-270. Nodes 264-270 represent a series of events and steps that if completed successfully lead to withdrawal of unauthorized funds by the attacker. Node 264 may represent the first step of the attack where the attacker may obtain compromised credentials (e.g., stolen credentials). The attacker may then access a financial account using the compromised credentials as illustrated in node 266. The attacker may change bank account details as illustrated in node 268. After changing the bank account details, the attacker may withdraw funds as illustrated in node 270.

FIG. 2H is a schematic that illustrates an attack graph 214, in accordance with an embodiment of the present disclosure. Attack graph 214 shows the sequential steps of a digital payment fraud attack. Attack graph 214 may include nodes 272-278. Nodes 272-278 represent a series of events and steps that if completed successfully lead to digital payment fraud by the attacker. Node 272 may represent the first step of the attack where the attacker may target a third party company system. The attacker may intercept data between a client device and the third party company. This may be referred to as adversary in the middle as illustrated in node 274. The attacker may change account details associated with a user of the client device as illustrated by node 276. The attacker may commit digital payment fraud as illustrated by node 278.

FIG. 3 is a schematic that shows quantum fraud Markov chains 300 with transition probabilities, in accordance with an embodiment of the present disclosure. A Markov chain may refer to a mathematical system that represents transitions from one state to the next state in a probabilistic manner. For example, the Markov chain may include a fraud attack state and a state transition probability. The state transition probability corresponds to the probability of transitioning from one state to another. Markov chains 300 shows the fraud states in a sequence and connected by a state transition probabilities with all possible transitions between states. The fraud attack state may represent a state of a fraud attack. The fraud attack state may be one of the attack states discussed in relation with FIGS. 2A-2H. Using quantum bits, multiple Markov chains may be simulated simultaneously. Each qubit may be in a superposition of probabilities that represent one or more fraud attack states. Thus, multiple attack paths and branches may be analyzed simultaneously. For example, quantum fraud Markov chains 300 shows multiple qubits: a first qubit 302, a second qubit 304, a third qubit 306, and a fourth qubit 308. The transition probabilities for each chain may be equal to one. The transition probabilities may be based on fraud data and used to model the Markov chain. At a time t, the value of qubits may be measured. Based on the measurement, quantum system 112 may determine whether any state indicates a fraudulent transaction. In some aspects, a classical measurement corresponding to the measurement of the qubit of one indicates that a compromise has occurred.

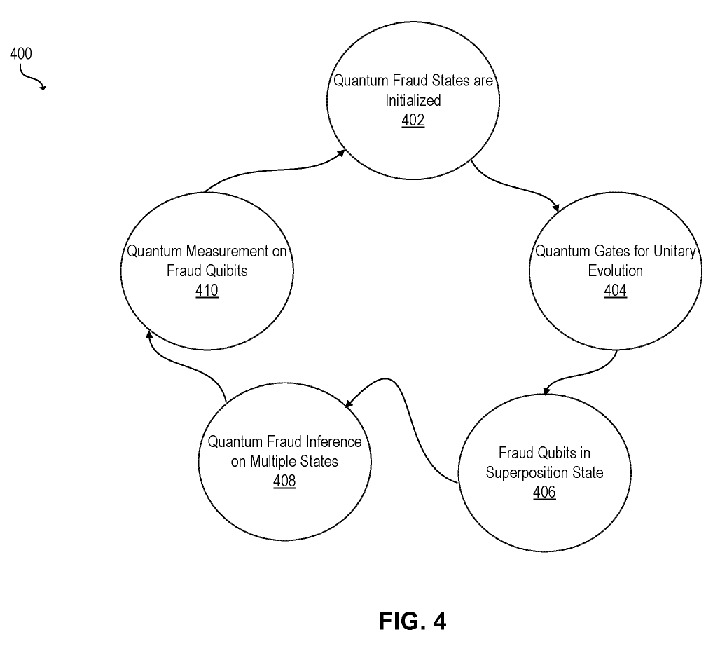

FIG. 4 is a schematic that shows a flow 400 of fraud analysis, in accordance with an embodiment of the present disclosure.

In 402, quantum fraud states may be initialized based on data received from fraud detection system 108. For example, the data may be normalized and encoded using an amplitude encoding algorithm. The encoded data may represent the amplitude of the quantum fraud states.

In 404, quantum gates of the quantum circuit that are used to represent a unitary evolution may be initialized. The quantum gates are unitary operations that carry out the evolution of the Markov chains. The application of the unitary operations in the quantum circuit simulates the evolution of the system represented as Markov chains.

In 406, the fraud qubits may be in superposition state in the quantum circuit. Thus, multiple Markov chains may be analyzed simultaneously.

In 408, quantum system 110 may store the result of measuring the quantum state. For example, quantum system 110 may apply a reconstruction algorithm such as a maximum likelihood reconstruction on the measurements of the quantum states.

In 410, quantum system 110 may measure the quantum bits that represent the collapse of the states of the qubits.

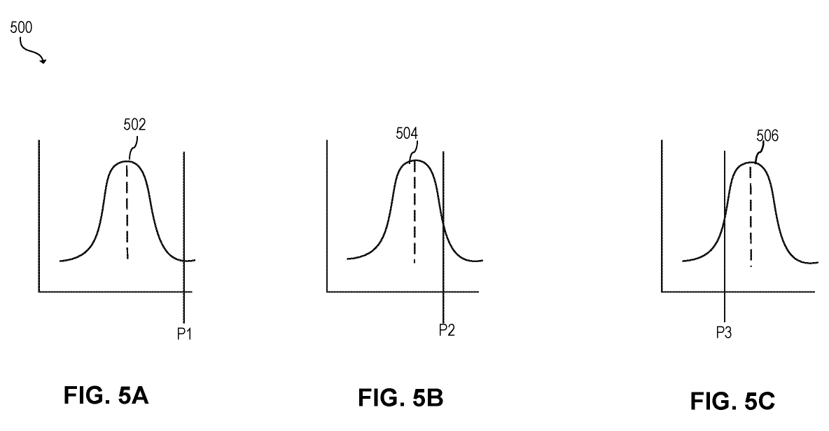

A quantum circuit may evaluate multiple Markov chains simultaneously to give the probabilities of various attacks given the data received by fraud detection platform 102. FIGS. 5A-5C shows example probabilities generated by fraud detection platform 102.

FIG. 5A is a graph 502 that illustrates a fraud probability, in accordance with an embodiment of the present disclosure. Graph 502 shows the probability of gift card, loyalty reward fraud given the runtime data received by fraud detection platform 102. The area of the region to the right of P1 corresponds to the probability of an attack.

FIG. 5B is a graph 504 that illustrates a fraud probability, in accordance with an embodiment of the present disclosure. Graph 504 shows the probability of digital payment fraud given the runtime data. The area of the region to the right of P2 corresponds to the probability of an attack.

FIG. 5C is a graph 506 that illustrates a fraud probability, in accordance with an embodiment of the present disclosure. Graph 506 shows the probability of account take over given the runtime data. The area of the region to the right of P3 corresponds to the probability of an attack.

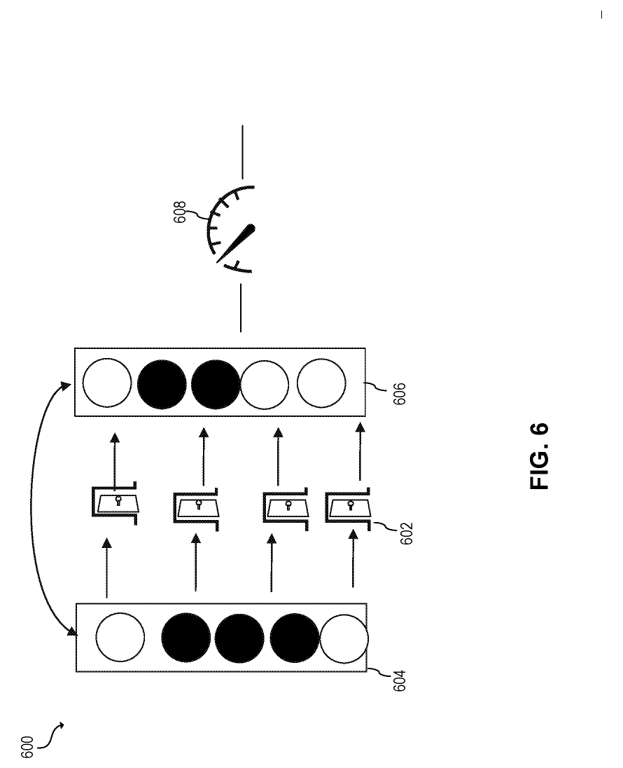

FIG. 6 is a schematic shows a quantum circuit 600, in accordance with an embodiment of the present disclosure. Quantum circuit 600 may include n qubits. A system of n entangled qubits may be in 2ⁿ states with different probabilities simultaneously. The 2ⁿ states may represent initial states 604 of the Markov chains or chains. Initial states 604 may correspond to the data received from application system 104 and/or middleware system 106 encoded as qubits. Quantum circuit 600 may be trained to determine transition probabilities based on at least an attack graph. For example, a plurality of quantum gates 602 may simulate the transition probabilities. The attack graph may comprise a plurality of fraud states as described in relation with FIGS. 2A-2H. The iteration of quantum circuit 600 simulates steps in Markov chain or chains to obtain output qubits or states 606. Each qubit of the plurality of qubits may be in a superposition of two or more fraud states of the plurality of fraud states. The measurement 608 of states of qubits 606 gives the probability of an attack.

In some aspects, a portion of the qubits available in quantum system 112 are used for error mitigation. Error mitigation may be used to reduce noise and errors in quantum circuit 600. For example, the portion of qubits may be used to store the information of one qubit in order to reconstruct the correct information if a single qubit receives an error.

### Methods of Operation

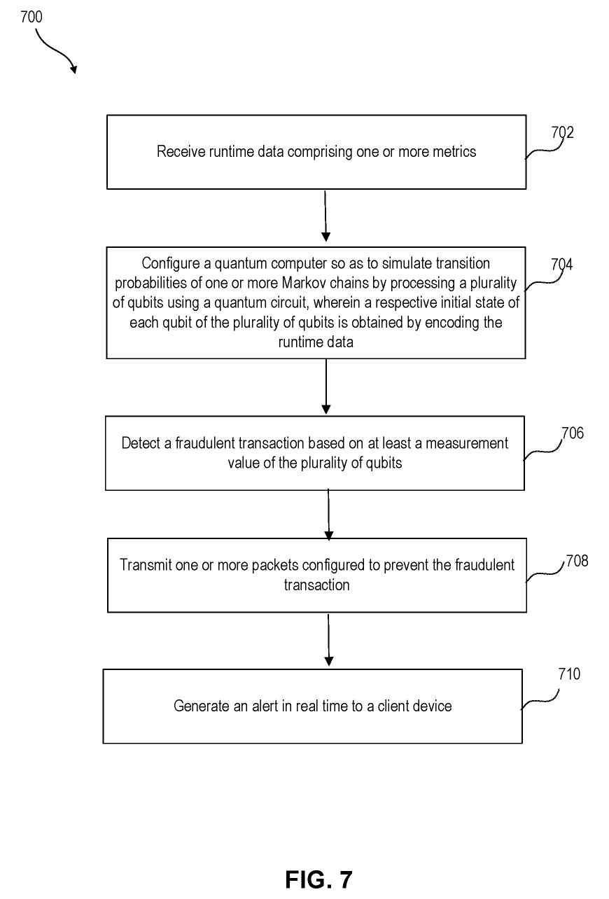

FIG. 7 is an example method 700 for detecting a fraudulent transaction, in accordance with an embodiment of the present disclosure. Method 700 may be performed as a series of steps by a computing unit such as a processor. For example, method 700 may be implemented by fraud detection system 108 and/or computer system 700 of FIG. 7. Method 700 shall be described with reference to FIG. 1, however, method 700 is not limited to that example embodiment.

In 702, fraud detection system 108 may receive runtime data from a client device (e.g., client device 116). The runtime data may include one or more metrics. In some aspects, the one or more metrics may be associated with a payment application. In some aspects, the one or metrics may be associated with a merchant system.

In 704, fraud detection system 108 may configure quantum system 112 so as to simulate transition probabilities of one or Markov chains. In some aspects, quantum system 112 may process a plurality of qubits using a quantum circuit. In some aspects, a respective initial state of each qubit of the plurality of qubits is obtained by encoding the runtime data. In some aspects, to encode the runtime data, fraud detection system 108 may apply an amplitude encoding algorithm to obtain the quantum input states. In some aspects, runtime data are normalize and forms the amplitudes of a quantum state.

In 706, fraud detection system 108 may detect a fraudulent transaction based on at least a measurement value of the plurality of qubits. In some aspects, fraud detection system 108 may obtain a classical measurement value from at least the measurement value. In some aspects, a classical measurement value of one may indicate a fraudulent transaction.

In 708, fraud detection system 108 may send one or more packets to the client device in response to detecting the fraudulent transaction. The one or more packets may be configured to stop or to prevent the fraudulent transaction. One or more actions may be triggered by the one or more packets based on the type of the transaction and the phase of the attack. For example, the one or more actions may comprise blocking access to a financial account associated with the fraudulent transaction (e.g., when the fraudulent transaction is detected at node 264 of FIG. 2G). In another example, the one or more actions may comprise blocking transactions to withdraw funds from the financial account associated with the fraudulent transaction (e.g., when the fraudulent transaction is detected at node 266 of FIG. 2G).

In 710, in response to detecting the fraudulent transaction, fraud detection system 108 may send an alert in real time to the client device.

It is to be appreciated that not all steps may be needed to perform the disclosure provided herein. Further, some of the steps may be performed simultaneously, or in a different order than shown in FIG. 7, as will be understood be a person of ordinary skill in the art.

### Components of the System

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof. For example, the method steps of FIG. 7 may be implemented via computer system 800.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/ any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
receiving, by a computer processor and from a client device, runtime data comprising one or more metrics;
configuring, by the computer processor, a quantum computer so as to simulate transition probabilities of one or more Markov chains by processing a plurality of qubits using a quantum circuit, wherein a respective initial state of each qubit of the plurality of qubits is obtained by encoding the runtime data;
detecting a fraudulent transaction based on at least a measurement value of the plurality of qubits; and
transmitting, by the computer processor to the client device, one or more packets configured to prevent the fraudulent transaction.

2. The method of claim 1, wherein encoding the runtime data comprises:
applying an amplitude encoding algorithm to encode the runtime data as quantum input states.

3. The method of claim 1, wherein the one or more metrics are associated with a payment application.

4. The method of claim 1, wherein the one or more metrics are associated with a merchant system.

5. The method of claim 1, further comprising:
in response to detecting the fraudulent transaction, generating an alert in real time to the client device.

6. The method of claim 1, wherein the quantum circuit is trained to determine the transition probabilities based on at least an attack graph; and
wherein the attack graph comprises a plurality of fraud states.

7. The method of claim 6, wherein a qubit of the plurality of qubits is in a superposition of two or more fraud states of the plurality of fraud states.

8. The method of claim 1, wherein detecting the fraudulent transaction comprises:
obtaining a classical measurement from the measurement value of the plurality of qubits; and
detecting the fraudulent transection when the classical measurement is equal to one.

9. A system comprising:
a memory; and
at least one processor coupled to the memory and configured to perform operations comprising:
receiving from a client device runtime data comprising one or more metrics;
configuring a quantum computer so as to simulate transition probabilities of one or more Markov chains by processing a plurality of qubits using a quantum circuit, wherein a respective initial state of each qubit of the plurality of qubits is obtained by encoding the runtime data;
detecting a fraudulent transaction based on at least a measurement value of the plurality of qubits; and
transmitting, to the client device, one or more packets configured to prevent the fraudulent transaction.

10. The system of claim 9, wherein the operations further comprises:
applying an amplitude encoding algorithm to encode the runtime data as quantum input states.

11. The system of claim 9, wherein the one or more metrics are associated with a payment application.

12. The system of claim 9, wherein the one or more metrics are associated with a merchant system.

13. The system of claim 9, wherein the operations further comprising:
in response to detecting the fraudulent transaction, generating an alert in real time to the client device.

14. The system of claim 9, wherein the quantum circuit is trained to determine the transition probabilities based on at least an attack graph; and
wherein the attack graph comprises a plurality of fraud states.

15. The system of claim 14, wherein a qubit of the plurality of qubits is in a superposition of two or more fraud states of the plurality of fraud states.

16. The system of claim 9, the operations further comprising:
obtaining a classical measurement from the measurement value of the plurality of qubits; and
detecting the fraudulent transection when the classical measurement is equal to one.

17. A non-transitory computer-readable device having instructions stored thereon that, when executed by at least one computing device, cause the at least one computing device to perform operations comprising:
receiving, from a client device, runtime data comprising one or more metrics;
configuring a quantum computer so as to simulate transition probabilities of one or more Markov chains by processing a plurality of qubits using a quantum circuit, wherein a respective initial state of each qubit of the plurality of qubits is obtained by encoding the runtime data;
detecting a fraudulent transaction based on at least a measurement value of the plurality of qubits; and
transmitting, to the client device, one or more packets configured to prevent the fraudulent transaction.

18. The non-transitory computer-readable device of claim 17, wherein encoding the runtime data comprises:
applying an amplitude encoding algorithm to encode the runtime data as quantum input states.

19. The non-transitory computer-readable device of claim 17, wherein the one or more metrics are associated with a payment application.

20. The non-transitory computer-readable device of claim 17, wherein the one or more metrics are associated with a merchant system.
